(19) United States
(12) Patent Application Publication
(10) Pub. No.: US 2026/0002519 A1
(43) Pub. Date: Jan. 1, 2026

(54) METHOD FOR VALIDATING A WIND POWER INSTALLATION

(71) Applicant: Wobben Properties GmbH, Aurich (DE)

(72) Inventors: Marcel WEBER, Aurich (DE); Matthias GIESLER, Aurich (DE)

(21) Appl. No.: 19/251,211

(22) Filed: Jun. 26, 2025

(30) Foreign Application Priority Data
Jun. 27, 2024 (EP) 24184857.1

(51) Int. Cl. F03D 17/00

(52) U.S. Cl. CPC F03D 17/021; F03D 17/011

(57) ABSTRACT

In one aspect, a method for validating a wind power installation or a component thereof is disclosed. The wind power installation has an aerodynamic rotor with a plurality of rotor blades that sweep through a rotor area. For at least one of the rotor blades, an individual blade performance capability and/or an individual blade power is/are determined in each case from recorded operating data relating to the wind power installation. The individual blade performance capability describes a capability of a rotor blade to convert power from wind into a partial rotational power for rotating the rotor, and the individual blade power denotes an amount of power that is converted by the respective rotor blade from the wind into a partial rotational power for rotating the rotor. The sum of the individual blade powers of all rotor blades of the rotor is a total rotational power of the rotor.

### TECHNICAL FIELD

The present disclosure relates to a method for validating a wind power installation or a component of the wind power installation. The present disclosure also relates to a corresponding wind power installation.

### BACKGROUND

Wind power installations are known and generate electrical power from wind using a rotor with in particular three rotor blades on the rotor. It is a common task to improve the performance of such wind power installations, and this also includes improving the rotor blades, specifically improving them aerodynamically, in particular.

For rotor blades, there are different types of additions, which can also be referred to as “add-ons”, which are intended to improve the flow states on the rotor blade. These include vortex generators, trailing edge serrations and Gurney flaps, to name just a few. Measurements from a wind tunnel and results from simulations often promise an improvement in the power curve when adding such add-ons or other measures. Performance gains can be in the range from 0.2 to 0.5 percent of annual energy production. However, such orders of magnitude often cannot be validated in a power curve measurement, since seasonal fluctuations in the power curve can amount to one to two percent of annual energy production. The seasonal fluctuations mentioned are particularly important if the power curve is determined in a first period of e.g. two to three months without “add-ons” on the rotor blade and in a second period with “add-ons” on the rotor blade. The respective resulting value of annual energy production that is formed from the power curves is then influenced too much by the seasonal fluctuations of the power curve, and so the effects of the “add-ons” on the value of annual energy production can be quantified only with difficulty.

It is therefore difficult to validate the results from the wind tunnel and the simulation. However, such validation is helpful in assessing the “add-ons” and deciding whether or not they should be added. All these considerations for the “add-ons” also affect other changes to the rotor blade, including a newly developed, i.e. different rotor blade. Each “add-on” can result in an increase in the price of the rotor blade and can possibly increase maintenance costs. Therefore, validation would be helpful in obtaining further indications of the mode of action, efficacy and/or achievable improvement in the “rotor blade add-ons”.

Previously, effects of add-ons on the power curve could be validated by first measuring a power curve on a wind power installation, which could take approximately two to three months. Then the “add-ons” were installed on the rotor blade and the power curve was measured again. However, due to the seasonal differences in the power curve, it was very difficult to draw conclusions from the performance of the “add-ons” determined in this way.

The disclosure is therefore based on the object of addressing at least one of the above-mentioned problems; in particular, the intention is to propose a solution in which effects of changes to the rotor blade on the performance of the wind power installation can be detected with high accuracy in order to thereby validate these effects. The intention is at least to propose an alternative to previously known solutions.

### SUMMARY

According to the disclosure, a method as claimed in claim 1 is proposed. According to this, a wind power installation or a component of the wind power installation is validated or assessed. This validation or assessment involves validating effects of individual elements of the wind power installation, in particular on its performance. In particular, rotor blades and/or changes to the rotor blades are validated and/or the effects of such changes, in particular on the performance of the rotor blades, are validated. This also validates the wind power installation as a whole, because the performance of the rotor blades has a direct effect on the performance of the wind power installation as a whole.

Such a wind power installation thus has an aerodynamic rotor with a plurality of rotor blades that sweep through a rotor area. In particular, three rotor blades are provided. Each rotor blade has a blade root with a blade root region, and the blade angle of each rotor blade is adjustable. In this respect, basically common rotor blades are used and the method concerns a common, pitch-controlled wind power installation.

It is then provided that, for at least one of the rotor blades, an individual blade performance capability and/or an individual blade power is/are determined in each case from captured operating data relating to the wind power installation. The individual blade performance capability describes a capability of a rotor blade to convert power from wind into a partial rotational power for rotating the rotor. The individual blade power denotes the amount of power that is converted by the respective rotor blade from the wind into a partial rotational power for rotating the rotor, with the result that a sum of the individual blade powers of all rotor blades of the rotor results in a total rotational power of the rotor.

The total rotational power of the rotor is thus the power that the rotor can draw from the wind. In a symmetrical and even case and with a rotor with three rotor blades, the individual blade power is thus one third of the total rotational power of the rotor.

However, it was recognized that such symmetry does not necessarily have to be present, and it was recognized in particular that there are possible ways of determining the individual blade power of each individual rotor blade, that to say in a way that the individual blade power is not just one third of the rotational power of the rotor. This opens up the possibility of operating the wind power installation simultaneously with different rotor blades and of recording and comparing individual blade performance capabilities, in particular individual blade powers. Possible ways of recording the individual blade power are described in detail below.

In any case, it was also recognized that determining the individual blade power can be used to assess the performance of an individual rotor blade and this opens up the possibility of determining the performance of individual rotor blades of a rotor of a wind power installation when the rotor blades of the rotor of the wind power installation are not the same. In that case, an individual blade assessment can be carried out.

Captured operating data relating to the wind power installation are used to determine the individual blade power and this may include the recording of blade loads in addition to a power curve of the wind power installation, which can also reflect time fluctuations with the rotation of the rotor. Other sensors can also be arranged on the respective blade or on the hub in the region of the respective blade root of the respective rotor blade and used to determine the individual blade power.

One aspect also proposes the following:

A method for validating or assessing a wind power installation, wherein the wind power installation has an aerodynamic rotor with a plurality of rotor blades that sweep through a rotor area, wherein
each rotor blade has a blade root with a blade root region and is adjustable in its blade angle; and
for at least one of the rotor blades, an individual blade property is determined in each case from captured operating data relating to the wind power installation, wherein
the individual blade property denotes an individual blade power, or another property of the rotor blade that affects the individual blade power, or a property of the rotor blade that is independent of the individual blade power.

Any methods and aspects described below in connection with the individual blade power, in particular for determining the individual blade power, are also accordingly applicable to the individual blade property and corresponding descriptions should also be understood as descriptions for individual blade properties which themselves do not have to relate to an individual blade power, even if this is not explicitly based in each case below on the individual blade property.

One aspect proposes that the individual blade power is determined on the basis of a load evaluation of the respective rotor blade. Here it was recognized in particular that a power recording or evaluation of the generator, or at least on the basis of power values of the generator, makes it difficult to make a quantitative statement about an individual blade power, but that the consideration of a load evaluation of the respective rotor blade allows such qualification. The load evaluation can be additionally taken into account, e.g. in addition to a total power recording and/or a speed of the rotor.

The individual blade power can thus be determined by taking into account the load evaluation of the respective rotor blade.

According to one aspect, it is proposed that the individual blade power is determined on the basis of a recorded blade load, in particular a recorded swivel load of the respective rotor blade, in particular at the blade root or in the blade root region of the respective rotor blade.

In particular, appropriate load sensors for recording swivel and impact loads may be present. The swivel load denotes a load, in other words a bending moment, on the rotor blade in the direction of rotation of the rotor, whereas an impact load denotes a load transversely to it. The swivel load is thus the principal torque on the rotor blade, which leads to the rotation of the rotor and thus power generation or conversion by means of the rotor blade.

However, corresponding measurement sensors are often arranged on the rotor blade at or near the blade root and are thus also rotated when the rotor blade is rotated. In this respect, a load recorded by a corresponding sensor is not necessarily directed exactly in the swivel direction, depending on the set blade angle of the respective rotor blade. In principle, a conversion to a swivel load is possible on the basis of the blade angle set and this is also suggested here in accordance with the present aspect. However, it should be noted that the accuracy of the swivel load calculated in this way can also depend on the blade angle set.

Thus, it was recognized in particular that such swivel loads already recorded can be used to determine the individual blade power.

According to one aspect, it is proposed that a temporal power curve of power generated by the wind power installation is recorded over at least one rotor rotation, power values of the power curve are each assigned to a rotor position, and the at least one individual blade power is determined from the assigned power values. In particular, it is provided that the at least one individual blade power is determined also taking into account a wind speed varying over the rotor area. Therefore, provision may be made to also record the wind speed and to also record how the wind speed varies over the rotor area.

It was recognized in particular here that a power value can be assigned in each case to a rotor position and thus also to a blade position and thus also to rotor blades from the temporal power curve, specifically if it is not constant over one revolution. This shall be explained using an illustrative example.

If the wind speed is assumed to increase with the height, a maximum power, i.e. maximum power generated by the generator, can occur in each case in the temporal power curve when a rotor blade points upward, i.e. is in a so-called 12 o'clock position. Three of these maximum power values could then be obtained over one rotor revolution. If these three maximum power values are the same—assuming that the wind speed has not changed during this one rotation of the rotor—all rotor blades generate the same amount of power, and so their individual blade power would be the same. However, if one of these maximum powers is higher than the other two, this rotor blade generates correspondingly more power and the individual blade power can be inferred thereby.

A determination of the level of the individual blade power can also be inferred from the level of this maximum blade power. However, interrelationships can be recorded in offline tests or via simulations. Also, the above-mentioned example should only be understood in a simplistic and illustrative way, and rather the entire temporal power curve is recorded.

In addition, a tower pass by a respective rotor blade can also provide information about the individual blade power. When a rotor blade is respectively in the 6 o'clock position, for instance, it enters the slipstream of the tower (which also exists in front of the tower due to stagnation pressure), and the power drop can be used to infer the individual blade power. If the power drop is higher in this case for one rotor blade than for another, a higher individual blade power can be assumed for this rotor blade with the higher power drop. Here, too, simulations or comparison measurements can quantify the individual blade power.

Especially when a corresponding measurement system such as a lidar is present, a decisive consideration of the wind speed varying over the rotor area can be recorded and taken into account. Which rotor blade is experiencing which wind speed at that moment should then be respectively assigned to the temporal power curve. This also allows the individual blade power to be recorded and also quantified; here too, the interrelationships can be established, for example by means of simulations.

According to one aspect, it is proposed that the determination of the individual blade power is repeated for a plurality of revolutions of the rotor, and/or is repeated with varying blade angles, and/or is repeated at different rotor speeds, and/or is repeated taking into account ambient conditions, in particular weather conditions.

The repetition for a plurality of revolutions of the rotor makes it possible to achieve a higher degree of accuracy of the determined individual blade power. In particular, slight wind fluctuations, which basically always occur, can essentially be averaged out by the determination over a plurality of revolutions of the rotor.

Repeating the determination with varying blade angles also makes it possible to carry out optimization in particular or to collect data for optimization. By determining the individual blade power, properties of the rotor blade are determined, in particular, and are thus also validated. The determination for varying blade angles therefore makes it possible to assess and also validate the performance of the rotor blade as a whole. As a result, a suitability of the rotor blade as a whole can be determined and, for example, conclusions can be drawn as to which blade angles can be useful for which operating point. In particular, an optimum blade angle can also be found thereby.

Determining the individual blade power with different rotor speeds therefore also makes it possible to determine the properties of the relevant rotor blade for different rotor speeds and thus also for different wind speeds and to determine inflow conditions on the rotor blade and to use them to assess the rotor blade.

The repetition taking into account ambient conditions, in particular weather conditions, makes it possible to assign the results found to these ambient conditions. It is therefore possible to assign which blade power was determined under which ambient conditions, i.e. under which weather conditions, in particular at which wind speed. This allows the suitability of the rotor blade for the corresponding ambient or weather conditions to be captured. In addition, comparisons, e.g. with other rotor blades, can be made in an improved manner. Such comparisons are particularly useful when the ambient conditions, in particular weather conditions, are the same, so that the same results are also compared. If, during such investigations of different rotor blades, the ambient conditions were not exactly the same, e.g. the wind speeds were not exactly the same, this can be taken into account by a compensation calculation.

However, even for the same rotor blade, which is examined, for example, for different revolutions, varying blade angles and/or different rotor speeds, the consideration, in particular recording, of ambient conditions for a later comparison and also for determining an overall picture of the properties of the rotor blade can be helpful.

In addition to weather conditions, in particular wind speeds, or else turbulence frequencies or turbulence intensities, ambient conditions can also relate to temperatures or the wind direction in connection with the location and type of obstacles in the environment.

According to one aspect, it is proposed that a repetition cycle of determining the individual blade power is initiated by detecting a changed blade angle, and/or a repetition cycle is initiated by detecting a changed rotor speed, and/or a repetition cycle is initiated by detecting at least one changed ambient condition, in particular weather condition.

In this respect, a repetition cycle is a cycle in which the determination of the individual blade power is repeated. For example, in a repetition cycle, the determination of the individual blade power can be repeated for five revolutions of the rotor. Thus, the individual blade power is then determined five times, namely for one revolution in each case. A single value for a blade power can be determined in particular from these five repetitions or five determined blade powers. In particular, by means of an average value of the five determined blade powers mentioned in this example. All of this was then carried out in one repetition cycle.

However, a repetition cycle can also in turn be initiated and thus repeated if it is not the first. For example, this takes place when a changed blade angle is detected. Thus, to take up the above example again, the determination of the individual blade power can be carried out five times with a blade angle, namely for one revolution in each case. If the blade angle is then changed, this is detected and a new repetition cycle is initiated. Then, for example, the individual blade power can be determined again five times, namely for five revolutions. However, it can also be repeated again and continued for further revolutions as long as the blade angle remains unchanged.

In any case, the individual blade power can be determined multiple times, i.e. repeated, in each repetition cycle in order to then obtain a common value. In a further repetition cycle, a different value is determined, which is based specifically on a different situation during determination.

Even in the case of a changed blade angle, this is referred to as the detection of such an angle, although a corresponding control signal can simply be used for this purpose. The detection of the changed blade angle therefore need not mean that a corresponding sensor was used and evaluated for this purpose.

The same applies to a changed rotor speed, which is of course known to the controller. However, the initiation of a repetition cycle is triggered after a changed speed has been detected. This can mean that the rotor speed has changed, for example, by a predetermined value, e.g. a percentage value.

A changed ambient condition, in particular a weather condition, such as a changed wind speed, can also initiate a repetition cycle, i.e. a new repetition cycle.

It was recognized here in particular that as a result a repetition cycle is always carried out for the same conditions. In particular, the repetition of determining the individual blade power can be repeated under the same conditions. If the conditions change, a new repetition cycle begins and a new individual blade power is then recorded. The individual blade power determined in a repetition cycle can then be stored together with the conditions prevailing at that moment. This makes it possible to create an overall database for individual blade powers under different conditions. In particular, the individual blade power determined in a repetition cycle is thus stored together with the blade angle and/or the rotor speed and/or at least one ambient condition, in particular a weather condition, in particular a wind speed.

According to one aspect, it is proposed that, in order to determine the individual blade power of a rotor blade, a load variable of the rotor blade is recorded, in particular in the region of a blade root of the rotor blade, a swivel load is determined taking into account the blade angle, and the individual blade power of the rotor blade is determined on the basis of the swivel load determined in this manner.

A swivel load is understood here as meaning a load on the rotor blade in the direction of rotation of the rotor. A load variable of the rotor blade can be recorded in particular in the region of the blade root of the rotor blade by means of corresponding force sensors, in particular strain gages.

Force sensors can also be located on castings, e.g. on a blade adapter, i.e. an adapter between the blade bearing and the rotor blade, which co-rotate with the rotor blade when adjusting the blade angle and are thus in a co-rotating coordinate system, or on a hub adapter, i.e. an adapter between the rotor hub and the blade bearing, which do not co-rotate with the rotor blade when adjusting the blade angle, and are thus in a non-co-rotating coordinate system.

If the force sensors are in a co-rotating coordinate system, they therefore co-rotate when adjusting the blade angle of the rotor blade and thus each indicate a force in relation to a direction of the rotor blade. For example, an elongation in the direction of a chord of the blade profile, or transversely to it. Taking into account the current blade position, i.e. the current blade angle, a force direction in the swivel direction, i.e. in the direction of rotation of the rotor, and thus the swivel load can be calculated from this force direction. In illustrative terms, the swivel load acts in the direction of rotation and thus drives the rotor. The swivel load is therefore one that contributes to the rotor power and thus blade power. In simple terms, the swivel load of a rotor blade can be considered to be proportional to the individual blade power.

Thus, the individual blade power of the rotor blade can be determined on the basis of the swivel load determined in this manner.

For example, the sum of the swivel loads of all rotor blades in steady-state operation can be set in relation to the generator power. The result is then a ratio between the sum of all swivel loads and the generator power, which is here simply equated with the rotor power, and the same ratio can be used to calculate the individual blade power of a rotor blade from the swivel load of this rotor blade.

According to one aspect, it is proposed that, in order to assess blade configurations, the wind power installation is operated in a test mode with differently configured blades, and, in the test mode, a load of one or more of the differently configured rotor blades is respectively recorded as a test load, and the at least one test load is compared with at least one further test load and/or with a reference load, and the performance capability of the at least one rotor blade is assessed on the basis of the comparison.

The idea here is thus to operate the wind power installation with different rotor blades at the same time. As a result of the fact that individual blade powers can be determined, it is thus possible to assess a plurality of different rotor blades at the same time. Here it is proposed in particular to respectively record a load as a test load for each of the differently configured rotor blades. If three differently configured rotor blades are thus used, three test loads can be recorded. This is particularly efficient, but there may be situations in which only one new blade or two new blades are actually available for testing. In this respect, differently configured blades can be different rotor blades and/or rotor blades with different attachments, that is to say e.g. different and/or a different number of vortex generators and/or vortex generators arranged at different locations. Other aerodynamic elements of the rotor blade can also be changed there, such as a blade trailing edge.

A test load is now recorded for each or every relevant rotor blade and these test loads can then be compared with each other. This comparison has the great advantage that identical conditions existed, especially of course the same rotor speed and essentially also the same wind conditions or other ambient conditions. As a result, the conditions are actually the same and differences in the test loads indicate different results due to the differently configured rotor blades. This allows the accordingly configured rotor blades to be assessed well.

According to one aspect, it is proposed that, in order to record or determine a changed blade performance capability resulting from a blade change in one of the rotor blades, in a first step, the wind power installation is operated in a reference mode without the blade change, in particular with the same rotor blades. In this reference mode, loads of the rotor blades are recorded as reference loads. In a second step, the wind power installation is operated in a test mode with the blade change, the blade change being carried out only for one of the rotor blades. The unchanged rotor blades can be considered to be reference rotor blades. In the test mode, loads of the rotor blades are recorded as test loads.

A changed individual blade power is determined on the basis of the recorded reference loads and the recorded test loads, and the changed blade performance capability is determined on the basis of the changed individual blade power. The blade performance capability, and thus also the changed blade performance capability, describes a property of the rotor blade of converting power from the wind into a partial rotational power. This property can be derived here from the current blade power, which basically describes or specifically specifies an instantaneous power, in particular as a power value in watts.

The blade performance capability can be specified, for example, as efficiency, or as a percentage value relative to the reference rotor blade. However, the blade performance capability can also be specified as a more complex relationship, which can specifically describe the capability to convert power from wind for different angles of inflow. For example, it is possible to specify an efficiency curve against an angle of inflow or blade angle, which curve indicates the efficiency accordingly for different angles of inflow or blade angles.

It is first possible to achieve the situation in which the reference mode creates a good comparison situation with which the operation of the wind power installation in the test mode can be compared. In particular, an attempt is made to have the same conditions in the reference mode and in the test mode, that is to say in particular to carry out the reference mode and the test mode with the same wind speed, the same blade angle and the same rotor speed. Slight deviations in the wind speed, which can easily occur, can be removed if necessary.

In addition, however, it is then proposed to replace a rotor blade or to configure it differently, in particular by means of aerodynamic attachments, and then to carry out the test mode. The test mode can then be compared with the reference mode on the one hand, but on the other hand the rotor blades can also be compared with each other. This is possible in particular by recording the individual blade power.

According to one aspect, it is proposed that, for the blade change, attachments are added, removed and/or changed only for one of the rotor blades, or different attachments are added, removed and/or changed for a plurality of rotor blades, and validation for the changed rotor blade is carried out on the basis of the determined, changed performance capability and/or changed individual blade power.

This allows a rotor blade to be individually changed and its effect to be immediately recorded and assigned to the rotor blade. In particular, the effect of attachments can be investigated thereby. Especially when different attachments are added, removed and/or changed for a plurality of rotor blades, the effect of these attachments can be tested efficiently, since a plurality of configurations can be tested in one run and thus compared. Based on this, the performance capability or the individual blade power can then be recognized as the actual result and validation for the changed rotor blade can be carried out on the basis of this.

According to one aspect, it is proposed that power monitoring is carried out on the basis of the determined individual blade powers, wherein in particular the determined individual blade powers are recorded as blade power curves, and, in order to monitor power, the blade power curves of the rotor blades are compared.

Thus, not only individual values are recorded as individual blade powers and compared if necessary, but comprehensive power monitoring is proposed. Comparing blade power curves makes it possible to perform the power monitoring of the rotor blades. This makes it possible to recognize whether a rotor blade respectively has overall, i.e. always or predominantly, better or worse power values, or whether these only exist in certain situations. Operating characteristic curves for the relevant rotor blade can also be determined on the basis of the power monitoring. Such power monitoring can also have blade-angle-dependent blade powers and suitable blade angles can then be selected on the basis thereof.

According to one aspect, it is proposed that blade power curves are recorded as curves over at least one rotor rotation and are set in relation to a revolving rotor position of the respective rotor blade in order to compare values of the blade power curves for the same rotor position in each case. In particular, it is proposed that all blade power curves refer to the same blade position, with the result that their values are always compared at the same blade positions in each case.

It can be expected in particular that the wind field in the region of the rotor area can change greatly, in particular but not only with the height. In most cases, the wind speed is lower further down than further up. Nowadays, rotor areas, i.e. the area swept through by the rotor, can have a diameter of 150 meters. There may also be differences in the region of the tower pass. When considering the individual blade power against blade loads, a gravitational component can also be added. Such a gravitational component can be removed with good knowledge, but if this is not completely successful, a similar gravitational component can be expected for all rotor blades, provided that the same rotor positions are compared in each case.

In any case, blade power curves can be shifted here with respect to their rotor position in such a way that the blade power curves of all three rotor blades have in particular an identical rotor position, e.g. the 6 o'clock position, as a reference value. This allows the blade power curves to be superimposed as diagrams or in a diagram. Variations that result from the rotation of the rotor should then essentially occur equally for all three rotor blades and thus all three blade power curves. Such variations can thus no longer distort the comparison of the rotor blades or their blade power curves.

For example, the blade power curve of one rotor blade can serve as a reference and remain unchanged, while the blade power curves of the other two rotor blades are shifted by 120° or 240° (or −120°) relative to the reference. For comparison purposes, two of these blade power curves shifted in this way can then be subtracted from each other in each case.

According to one aspect, it is proposed that blade angles of the respective rotor blade are examined, in particular measured, on the basis of the determined individual blade power, wherein, during operation, the blade angle of a rotor blade is changed, in particular continuously or in a plurality of steps. This can be carried out until the individual blade power of this rotor blade decreases, in particular until the individual blade power of this rotor blade decreases relatively in relation to a reference blade power determined by the other rotor blades.

This makes it possible to examine and measure different rotor blades that are installed on the wind power installation, even if the same rotor blades having different attachments are provided. This makes it possible to carry out such validation and/or measurement of rotor blades essentially in a third of the time, compared to the fact that otherwise exactly three identical rotor blades are always present and analyzed during an examination. In particular, changing the blade angle until the individual blade power of the rotor blade decreases makes it possible to recognize the region in which the blade delivers optimum power relative to the blade angle, and from where this region is exited.

According to one aspect, it is proposed that the rotor blade whose blade angle has been changed is changed until this rotor blade is in a stall mode, and the blade angle at which the stall mode starts is recorded as the stall blade angle and identifies the rotor blade. Such a stall blade angle is an important property of the rotor blade. On the one hand, operation or an operating characteristic curve of a wind power installation can be adapted to it, namely that the wind power installation is operated in such a way that this stall blade angle is avoided.

On the other hand, this also allows rotor blades to be compared with each other, namely to what extent such a stall blade angle is away from an optimum, i.e. optimum-power, blade angle. In simple terms, the greater a distance between the optimum blade angle and the stall blade angle, the more tolerant the rotor blade is against fluctuations in an angle of inflow. Accordingly, even with otherwise identical properties, that rotor blade which has a greater distance between the optimum blade angle and the stall blade angle can be selected or favored.

According to one aspect, it is proposed that the examination of the blade angle, in particular the recording of the stall blade angle, is carried out while simultaneously recording a tip speed ratio and is assigned to the tip speed ratio recorded in this manner, and this assignment is stored for the purpose of identifying the rotor blade, in particular in a lookup table or a database. Thus, the relevant rotor blade can be characterized accordingly and a suitable rotor blade can be selected on the basis of this characterization. A wind power installation with such a rotor blade according to such a characterization can also be operated accordingly. The data can be accessed in particular depending on the tip speed ratio, and it is possible to detect how much reserve is available up to a stall range. The installation can then also be operated using different tip speed ratios in such a way that a stall range is avoided.

According to one aspect, it is proposed that, in order to improve, in particular optimize, the operation of the wind power installation for at least one rotor blade, the blade angle is gradually changed in each case, and changes in the individual blade power of the rotor blade whose blade angle has been changed in each case are recorded. In particular, provision is made for individual blade powers of the unchanged rotor blades to be used as a reference blade power. In this case, not all three rotor blades are then changed, but at best two.

Thus, the blade angle of at least one rotor blade is gradually adjusted and the effect on the individual blade power of this rotor blade is checked. If the individual blade power increases, an improvement through its blade adjustment can be inferred. As a result of the fact that a plurality of rotor blades can be changed at the same time, for each of which the change in the individual blade power is then observed, improvement possibilities can be identified more quickly compared to a variant in which all rotor blades are changed at the same time in order to check an influence on the power generated overall.

As a result of the fact that one rotor blade remains unchanged, it can be used as a reference, and power fluctuations caused by wind fluctuations can be removed. Fluctuations in the individual blade power of the reference rotor blade are due to wind fluctuations, and different changes in the individual blade power of the rotor blade or rotor blades, for which the blade angle has been changed, are then due to these changes in the blade angle.

However, the optimization can also be performed without taking into account a reference blade power of a reference rotor blade, i.e. even if the blade angle of all rotor blades is changed. This can be carried out in such a way that, in a first step, the blade angle of one rotor blade is reduced or increased compared to the other blade angles. This can be carried out for one rotor blade, for two rotor blades or for all rotor blades, wherein, when the blade angles of a plurality of rotor blades are changed, they are expediently changed differently.

In a second step, it is possible to compare which blade provides the highest power, i.e. the highest individual blade power.

In a third step, the blade angles of all rotor blades can then be set to the angle of the rotor blade which, according to step two, has achieved the highest power, i.e. the highest individual blade power.

The first to third steps can be repeated in order to thereby achieve an improvement or even an optimum through an appropriate iteration.

Preferably, such optimization according to steps 1 to 4 is carried out at the beginning of a start-up or restart in order to then find a good blade angle for all rotor blades. This routine, i.e. steps 1 to 4, can be repeated regularly, in which case it is proposed to carry out the repetitions less frequently after initial optimization according to step 3. As soon as an optimum blade angle has been found in this way, the optimization method can also be adjusted in this sense; however, due to changes that can occur again and again, e.g. due to blade soiling, rain that occurs or rain that has stopped again, it may be useful to repeat said optimization steps occasionally, but since such changes do not occur frequently and quickly, these optimization steps can then be carried out less frequently.

It should be noted that an optimum blade angle can depend on many factors, including, for example, tip speed ratio, speed, delivered or generated power, air density, that rain is present or that there is no rain, and wind shear.

According to one aspect, it is proposed to create a database with optimum blade angles, depending on the boundary conditions, and to select or interpolate the optimum blade angle therefrom during operation, depending on the boundary conditions.

According to one aspect, it is proposed to re-optimize the blade angle again in each case after a change in boundary conditions. Preferably, the above-mentioned database is used as a starting point for the iterative blade angle optimization, if such a database is available. Optionally, the database entry could then be updated for the respective boundary conditions. For this purpose, a weighted averaging of the new blade angle with the old optimum blade angle can be carried out for the corresponding boundary conditions.

According to one aspect, it is proposed that an optimum blade angle is identified on the basis of the recorded change in the individual blade power of the rotor blade whose blade angle has been changed, and the optimum blade angle is assigned in each case to an operating situation, in particular a recorded tip speed ratio, and stored in a database with the assigned operating situation. Like the previous aspect, this also concerns a rotor with three identical rotor blades, and an improved, in particular optimum, blade angle is thus found for these three identical rotor blades according to the manner described with the previous aspect.

However, the entire rotor must then be operated with this optimum blade angle, that is to say the blade angle must be set for all rotor blades of the rotor. Accordingly, this blade angle is stored together with the operating situation in which it occurred. This allows a database to be set up and, whenever this operating situation occurs again, it is possible to use the blade angle which is stored as the optimum blade angle. For operating situations for which no data are stored, an interpolation can be carried out based on stored data relating to two similar operating situations.

According to one aspect, it is proposed that the optimum blade angle for each rotor blade is recorded and stored on the basis of a rotary position of the rotor blade, and/or a sinusoidal curve dependent on the blade position is derived on the basis of a plurality of recorded optimum blade angles.

As in the previous two aspects, this also involves a rotor with the same rotor blades. This is additionally based on the idea of operating the wind power installation with a single blade adjustment. A single blade adjustment means that rotor blades are adjusted individually, i.e. substantially independently of the other rotor blades. Here, provision is made in particular for the rotor blade angle to be adapted to the respective rotary position of the rotor blade. In other words, provision may be made for a rotor blade in the 6 o'clock position to have a different blade angle than in the 12 o'clock position. The rotor blade therefore changes its blade angle with each revolution of the rotor. To take up this example again, the rotor blade then therefore has a different blade angle in the 6 o'clock position than in the 12 o'clock position. The rotor blade can change between these blade angles constantly, in particular continuously, during operation. Since the three rotor blades of a rotor are naturally always in different rotary positions at one time, the rotor blades assume different blade angles at identical times when their blade angles are constantly adjusted during a revolution of the rotor.

Accordingly, a blade angle curve can be provided for each rotor blade, which depends on the rotary position. Such a curve can have a particularly sinusoidal appearance and, accordingly, such a sinusoidal curve can be parameterized from recorded optimum blade angles over only a few rotary positions. Such a curve is then the same for each rotor blade, in relation to the rotary position. Over time, however, such curves for the three rotor blades of a rotor are shifted with respect to each other, namely by one third of the time needed by the rotor at that moment for one rotor revolution.

According to one aspect, it is proposed that the individual blade powers over at least one rotor revolution are determined for all rotor blades of the wind power installation as blade power curves, and the blade power curves are compared, and blade deviations are derived from the comparison as deviations with respect to a normal rotor blade. In addition to incorrect blade positions, such blade deviations can also be soiling, in particular a degree of soiling, icing, or damage. Damage can be caused by the fact that attachments have fallen off, and so the rotor blade can continue to be operated as such. Wear can also be a deviation with respect to a normal rotor blade.

In this respect, a normal rotor blade is one that has the properties that are assumed when constructing the wind power installation and thus installing the rotor blade. Optionally, such blade deviations can be rectified as soon as they have been detected. Rectification can include a repair, that is to say e.g. reattaching an attachment that has fallen off. Rectification may also involve cleaning the rotor blade or de-icing. A modified, alternative operating mode could also be initiated. The purpose of the modified operating mode could be to protect the wind power installation from inadmissibly high operating or extreme loads that could be caused by the aerodynamic rotor imbalance.

Additionally or alternatively, it is proposed that a different blade angle, in particular an incorrect blade position, can be derived from the comparison of the blade power curves and optionally corrected. An incorrect blade position can also be a blade deviation as a deviation with respect to a normal rotor blade. An incorrect blade position denotes a deviation between the actual blade angle and an assumed blade angle. In particular, the assumed blade angle can be one that was recorded by a corresponding sensor. However, an assumed blade angle can also result from good knowledge of the blade adjustment carried out.

An incorrect blade position in which a blade angle recorded by a sensor deviates from the actual blade angle may be caused by inaccurate mounting of the rotor blade or the blade sensor. However, sensor drift also comes into consideration if the corresponding blade angle sensor does not have an absolute marker. A deviation can also arise if the blade angle results from the blade adjustment operations carried out. Blade adjustment operations are often carried out using the specification of pitch rates, i.e. adjustment speeds for the blade angles. An absolute blade angle then results from an initial blade angle and integration over this pitch rate, which can be susceptible to drift.

In particular if an incorrect blade position is detected, this can be easily corrected by recalibrating the sensor or by providing an appropriate offset in the software or the process computer used to control the blade adjustment or its evaluation.

Additionally or alternatively, it is proposed that the individual blade performance capability is derived from a load signal from an impact load sensor, in particular without using a load signal from a swivel load sensor. A swivel load sensor is a sensor that records a load in the direction of rotation of the rotor when the rotor blade is in a normal operating position, i.e. essentially has a blade angle of 0°. An impact load sensor is one that records a load perpendicular to the rotor area in this blade position.

The two sensors, i.e. both the swivel load sensor and the impact load sensor, of which a plurality can also be provided in each case, are usually arranged in the region of the blade root on the rotor blade, that is to say are also changed when the blade angle changes. In order to determine an individual blade performance capability, in particular an individual blade power, the torque in the direction of rotation, i.e. the swivel load, is important. However, if the rotor blades are twisted, a load in the swivel direction can also be derived from the impact load sensor and used to calculate the individual blade performance capability, in particular the individual blade power.

In particular when a wind power installation does not have a swivel load sensor, it is advantageous to determine the individual blade performance capability or the individual blade power without taking such a load signal from a swivel load sensor into account. Taking into account the specific blade angle, this is thus also possible by means of an impact load sensor. This was recognized here and is proposed as a solution.

However, it was also recognized that some blade deviations can be determined solely from an impact load. This may also include an incorrect blade position, in which, depending on the blade angle, an incorrect position can be derived solely from the shear force of the wind on the rotor blade, in particular if it is set approximately in the region of 0°. The incorrect position leads to a changed impact load and is thus an indicator of this incorrect blade position.

It was also recognized that differences solely due to the impact load allow conclusions to be drawn about other blade deviations, such as soiling, icing or attachments that have fallen off.

According to one aspect, it is proposed that, when comparing changed rotor blades, boundary conditions, in particular environmental conditions, are recorded and taken into account. Such environmental conditions may be wind speed, air density and/or air humidity. Such environmental conditions affect the operation of the wind power installation and thus also the performance capability of the rotor blades, and in particular also the individual blade powers of the rotor blades. The recorded blade performance capabilities or blade powers can be assigned to these boundary conditions by taking these boundary conditions into account. This allows a more precise assessment of the rotor blades. In particular, an exact comparison of rotor blades is possible if blade performance capabilities or blade powers are compared in each case for the same boundary conditions.

It is therefore proposed in particular that comparisons are made for the same or at least similar boundary conditions and/or changed boundary conditions are taken into account, in particular changed boundary conditions are removed, by means of a conversion rule. These are in particular boundary conditions that are similar. Here, if a blade performance capability or a blade power is available for two similar boundary conditions of a rotor blade, values for further nearby boundary conditions can be taken into account by interpolation or extrapolation, depending on where these boundary conditions are.

According to one aspect, it is proposed that a separate measurement device, in particular a wind measurement mast, is used to record boundary conditions, in particular environmental conditions. Here it was recognized that measurements of higher accuracy or higher quality can be carried out by such a separate measurement device. In particular, it was recognized that the rotor itself can influence measurement devices on the wind power installation. If necessary, the influence is even dependent on the specific rotor blade. As a result, the assessments can be distorted if different boundary conditions are therefore assumed due to such measurement errors. Such influences of the rotor on the measurement device are avoided by means of a separate measurement device, in particular separate from the wind power installation, such as a wind measurement mast.

The disclosure also proposes a wind power installation, wherein the wind power installation has an aerodynamic rotor with a plurality of rotor blades that sweep through a rotor area, and
each rotor blade has a blade root with a blade root region and is adjustable in its blade angle; and
the wind power installation is prepared to carry out a method for validating the wind power installation or a component of the wind power installation, with which
for at least one of the rotor blades, an individual blade performance capability and/or an individual blade power is/are determined in each case from captured operating data relating to the wind power installation, wherein
the individual blade performance capability describes a capability of a rotor blade to convert power from wind into a partial rotational power for rotating the rotor, and the individual blade power denotes an amount of power that is converted by the respective rotor blade from the wind into a partial rotational power for rotating the rotor, with the result that a sum of the individual blade powers of all rotor blades of the rotor results in a total rotational power of the rotor.

The wind power installation is prepared in particular to carry out the method for assessing the wind power installation by virtue of the fact that such a method is implemented in the wind power installation, in particular in a process computer and/or in an installation controller.

According to one aspect, it is proposed that the wind power installation has a control device that can be used to control the wind power installation and to record and process measurement signals. Such a control device can therefore be used not only to control the wind power installation, but also to record and process measurement signals, namely in particular in the manner proposed for carrying out a method according to at least one of the aspects explained above.

Additionally or alternatively, it is proposed that the wind power installation, in particular the control device, is prepared to carry out a method according to one of the aspects explained above, or to initiate corresponding method steps of such a method. The method according to the aspects explained above includes control and evaluation steps that can be carried out by the control device. However, it also includes steps such as replacing a rotor blade or changing attachments, or cleaning a rotor blade. Such activities naturally cannot be carried out, but can be initiated, by a control device. Such initiation can take place in particular by virtue of the fact that a corresponding request is output on a display, or is given as a signal to a control center via a remote connection, so that then in particular service personnel carry out these activities, such as the replacement of a rotor blade.

The control device can be part of an installation controller or correspond to the installation controller.

According to one aspect, it is proposed that the wind power installation, in particular its control device, is prepared to identify individual rotor blades on the rotor and assign them to a mounting position on the rotor. This functionality of the wind power installation is provided in particular so that individual blade assessments or blade validations can also be assigned to the correct rotor blade.

This identification can be configured such that, for the relevant mounting position, the rotor blade, which is mounted or is intended to be mounted there, can be input together with properties of the rotor blade via an input interface. Such an input, for which an input mask may be provided, is then assigned to the corresponding mounting position.

The rotor is usually constructed in such a way that it has a rotor hub to which the rotor blades are fastened, namely mounted. Such a hub for three rotor blades accordingly has three receiving flanges for receiving one rotor blade each. These corresponding three receiving flanges are all usually identical. For the individual assessment of the rotor blades, these flanges mentioned, which can be regarded as a mounting position, must be able to be distinguished from each other. One possibility is that a rotary sensor that records the rotation of the rotor and thus the rotation of the hub can identify an absolute position of the rotor or hub. For example, a corresponding reference line or other reference indicator can be provided for this purpose. This can be used to identify the individual mounting positions, and this can be used to identify the rotor blades mounted in each case.

Optionally, provision is made for determined individual blade performance capabilities, in particular determined individual blade powers, to be able to be assigned to the identified rotor blade. Corresponding data sets or memory structures can be provided for this purpose. In particular, such an assignment can be achieved by means of a corresponding control program which can be implemented on the control device. The wind power installation or control device can thus be prepared to make such an assignment. For example, the input properties of the mounted rotor blade can be assigned to the mounting position. If further properties are discovered during the examination or assessment, in particular individual blade performance capabilities or individual blade powers, these can be added to the data set that is assigned to the corresponding mounting position and thus to the individual rotor blade.

### BRIEF DESCRIPTION OF THE DRAWINGS

The disclosure is explained in more detail below by way of example on the basis of exemplary embodiments with reference to figures.

FIG. 1 shows a perspective illustration of a wind power installation.

FIG. 2 schematically shows a wind power installation with indicated swivel and impact load sensors for determining an individual blade power.

FIG. 3 shows three individual blade power curves in a time diagram and in a rotor position diagram.

FIG. 4 shows a flowchart for optimizing blade angles for the same rotor blades.

FIG. 5 shows a diagram for measuring and/or validating different rotor blades.

### DETAILED DESCRIPTION

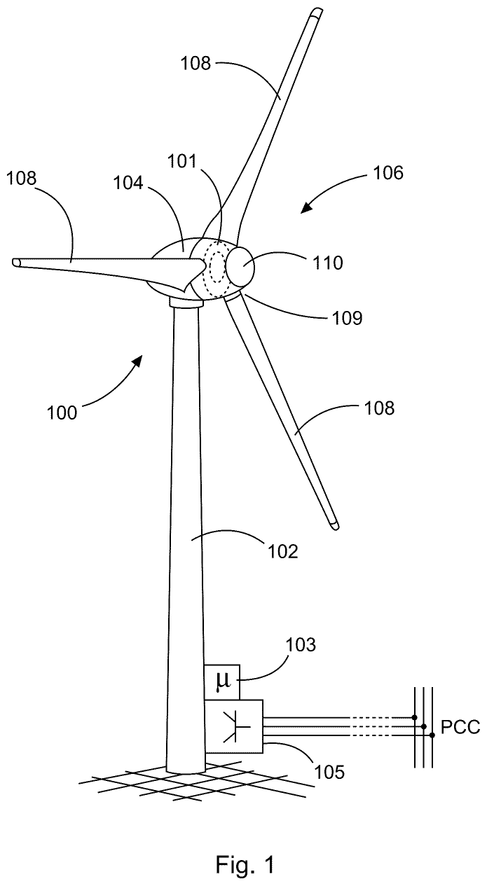

FIG. 1 shows a wind power installation 100 with a tower 102 and a nacelle 104. A rotor 106 having three rotor blades 108 and having a spinner 110 is disposed on the nacelle 104. During operation, the rotor 106 is set in rotational motion by the wind and in this way drives a generator in the nacelle 104.

The wind power installation 100 in this case has an electric generator 101, which is indicated in the nacelle 104. Electrical power can be generated by way of the generator 101. An infeed unit 105, which may be designed in particular as an inverter, is provided for the purpose of feeding in electrical power. It is thus possible to generate a three-phase infeed current and/or a three-phase infeed voltage in terms of amplitude, frequency and phase, for feeding in at a grid connection point PCC. This may be performed directly or else together with other wind power installations in a wind farm. An installation controller 103 is provided for the purpose of controlling the wind power installation 100 and also the infeed unit 105. The installation controller 103 may also receive predefined values from an external source, in particular from a central farm computer.

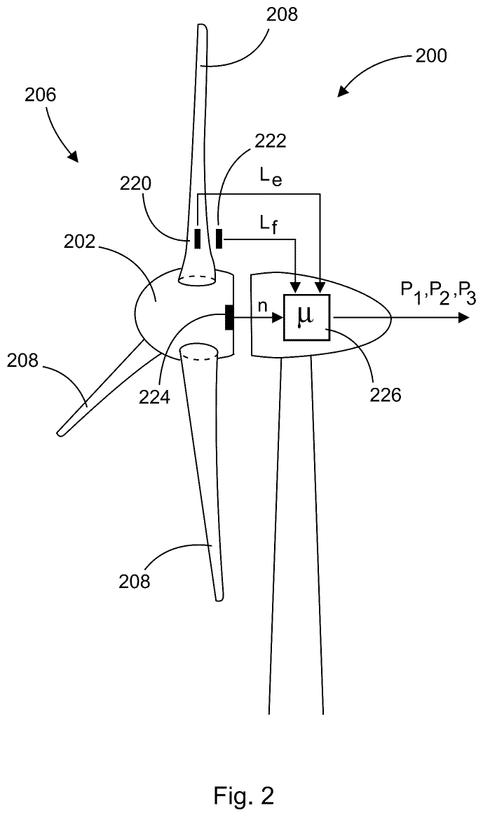

FIG. 2 schematically shows a wind power installation 200 with a rotor 206 having three rotor blades 208 which are mounted on a rotor hub 202. In particular, the rotor blades 208 are shown schematically and are intended to have an exemplary position of 0°, i.e. an operating position that would be assumed, in particular in partial load operation. A swivel load sensor 220 and an impact load sensor 222 are shown by way of example on one of the three rotor blades 208. A rotary sensor 224 which can record a speed n of the rotor 206 is also indicated.

The swivel load sensor 220 records a swivel load Lₑ and the impact load sensor 222 records an impact load L_{f}. The swivel load Lₑ and the impact load L_{f} are input together with the rotor speed n to a control device 226 of the wind power installation 200. The control device 226 can use them to determine an individual blade power P₁ for this one rotor blade 208. In the same way, an individual blade power P₂ and P₃ can also be determined accordingly for a second and third rotor blade 208 if the swivel load Lₑ and the impact load L_{f} of the respective rotor blade are also recorded and taken into account. However, it is also possible to manage only with the swivel load Lₑ or only with the impact load L_{f} and to determine the corresponding individual blade powers together with the rotor speed n.

In this respect, the swivel load Lₑ denotes a load that is directed in the swivel direction, i.e. in the direction of rotation of the rotor 206, and is accordingly also suitable for driving the rotor in its direction of rotation. The impact load L_{f} is a load that basically pushes the respective rotor blade toward the wind power installation. Such an impact load L_{f} can hardly contribute to the rotation of the rotor 206 in the situation indicated in FIG. 2 and can therefore also hardly provide any information about the respective individual blade power of the rotor blade. However, it can provide information about a performance of the rotor blade, e.g. about a degree of soiling or the influence of an attachment, depending on where exactly this attachment is arranged. In this respect, it was recognized that the consideration of the impact load L_{f} can be helpful for this reason alone, and so its consideration is proposed.

However, as soon as the blade angle of the relevant rotor blade is changed, the impact load L_{f} recorded by the impact load sensor 222 can also contribute to the rotation of the rotor and can thus also contribute to the individual blade power of the respective rotor blade. An individual blade power can then also be read or derived from the impact load L_{f}.

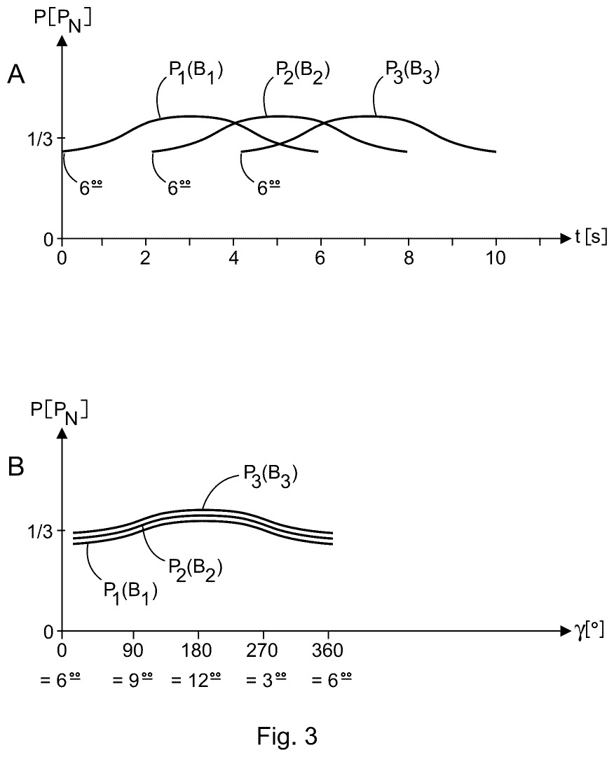

FIG. 3 shows a diagram A and a diagram B. Both diagrams show a curve of an individual blade power for a respective rotor blade B₁, B₂ and B₃. In simple and illustrative terms, the basis for this is a situation in which the wind power installation generates nominal power P_{N}, for example. Each rotor blade thus generates about one third of nominal power. In this respect, the ordinates of the two diagrams A and B are the same.

Diagram A shows the three individual blade power curves P₁, P₂ and P₃ in each case for the relevant rotor blade B₁, B₂ and B₃ over time. In simple terms, a wind power installation having a rotor speed of 10 rpm in the situation shown was assumed here, such that the rotor rotates completely once in 6 seconds (6 s). Such a speed can be assumed for small and medium wind power installations. Larger wind power installations would tend to rotate somewhat more slowly, but this is not important in the schematic illustration.

At the time t=0 s, the rotor blade B1 or the rotor relative to the rotor blade B1 is in a 6 o'clock position, which is indicated in diagram A. The fact that the rotor is in a particular position, such as the 6 o'clock position, relative to a particular rotor blade is referred to here in simple terms in such a way that the particular rotor blade is in the particular position, such as the 6 o'clock position. In any case, it is assumed that the basis here is also a situation in which the wind speed in a lower region of the rotor field or the rotor area is lower than in the upper region. This results in the power fluctuations. Shading by the tower is not taken into account here.

Accordingly, the curve of the individual blade power P₁ at the time t=0 s has a minimum value, which rises to a maximum value after 3 s when the rotor blade is in a 12 o'clock position.

Accordingly, the curves of the individual blade power for the second and third rotor blades B₂ and B₃ are shifted by 2 and 4 seconds respectively compared to the curve of the first rotor blade B₁. The second rotor blade B₂ is therefore in a 6 o'clock position after 2 seconds and the third rotor blade B₃ is in a 6 o'clock position after 4 seconds.

As can be seen in diagram A, the three power curves in the illustration selected there cannot be compared very well with each other. Accordingly, according to diagram B, an illustration is selected in which the power curves P₁ to P₃ are shown on the basis of the rotor position, i.e. the rotor rotation angle γ. As a result, the three curves are in phase and can be easily compared. This is intended to be illustrated in FIG. 3B which thus shows the curve of the individual blade power for each of the rotor blades over one revolution, starting with the 6 o'clock position, which is shown there as 0°.

Of course, a diagram need not necessarily be selected for such a power comparison. Instead, a difference can also be formed between the recorded curves of the individual blade power for each or many rotor positions.

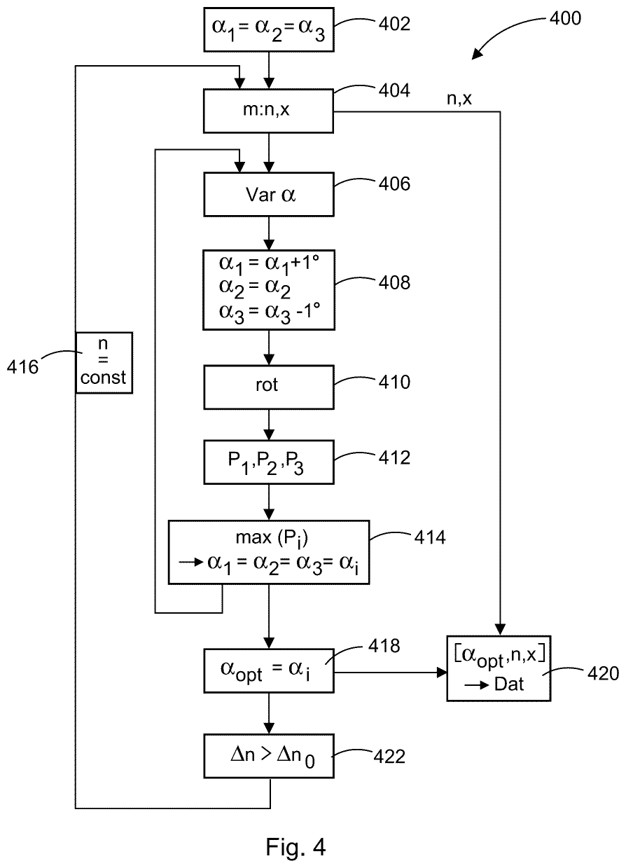

FIG. 4 shows a flowchart 400 which is intended to be used to find optimum blade angles. For this purpose, the wind power installation has three identical rotor blades, and they fundamentally have the same blade angles α₁=α₂=α₃ during operation and also at the start of the optimization sequence, which is indicated by the start step 402.

Boundary conditions are recorded in the measurement step 404. In particular, the speed is recorded and various further boundary conditions, of which the character x is representative, can be recorded. The further conditions can be, for example, air density, air humidity, air pressure, temperature or even gustiness or gust intensity.

In the variation step 406, the blade angles are then varied. In the variation step 406, criteria can be taken as a basis for this purpose, for example, such as less variation in the blade angles than in an earlier run.

In any case, the blade angles α₁, α₂ and α₃ are then set accordingly in the adjustment step 408. In this respect, in the adjustment step 408, FIG. 4 indicates by way of example that the blade angle α₁ is increased by one degree (1°), the blade angle α₂ remains unchanged, and the blade angle α₃ is reduced by one degree (1°), but in the negative direction. However, this is for illustration purposes only and other values can be used. The blade angles α₁ and α₃ also do not have to be changed by the same value only with a different sign. It also comes into consideration that the blade angle α₂ is also changed.

However, not changing the blade angle α₂ is a preferred variant in which the blade angle α₂ can then serve as a reference blade angle or the associated rotor blade can serve as a reference rotor blade. Such an unchanged reference rotor blade can be used to provide a corresponding reference and it can thus be recognized whether the wind speed has changed somewhat. In other words, the reference rotor blade whose blade angle has not been changed can be used to detect whether the individual blade power has changed without changing the blade angle.

The wind power installation is then operated in the operating step 410 with the blade angles set in this way. The wind power installation is therefore operated with the blade angles set in the adjustment step 408. Of course, this does not mean that it has to be stopped in order to adjust the blade angles, but rather it can continue to be operated normally, while the blade angles are adjusted during such operation. In this respect, the operating step 410 indicates that the wind power installation is operated with the newly set blade angles for a certain moment, in particular at least for one revolution of the rotor.

In the recording step 412, an individual blade power P₁, P₂ and P₃ is then determined for the corresponding three rotor blades. For this purpose, corresponding blade loads can be determined, which is not mentioned here in FIG. 4. The recording can be carried out in the manner explained in connection with FIG. 2, and the evaluation, in particular a comparison, can be carried out in the manner explained in connection with FIG. 3.

In the optimization step 414, it is then checked which of the three individual blade powers was the largest. Then, that is to say on the basis of this, the blade angle at which the individual blade power was the largest is selected for all three rotor blades.

The sequence then branches back to the variation step 406, wherein the test step 416 checks whether the speed is still constant. This is because, as long as the speed is still constant, the wind speed is also assumed to be unchanged, and then the process can be repeated in order to possibly find an even better blade angle. Accordingly, the sequence is then repeated according to steps 406 to 414.

In particular, a different variation than before is performed in the variation step 406. In particular, on the basis of the result of the optimization step 414, it comes into consideration to recognize a promising direction of change and to vary the blade angles accordingly. However, it also comes into consideration to set the same variation as in the run before. This can be provided in particular if it was found in the optimization step 414 that the reference blade angle was the best, i.e. no variation was performed. Then the same variation can be performed for checking. However, a variation with minor changes can also be performed, that is to say e.g. instead of increasing and decreasing by one degree (1°) in each case in a first run, increasing and decreasing by half a degree (0.5°) in each case in the second run.

After a plurality of runs, in particular if the individual blade powers no longer increase despite variation of the blade angle, it can be assumed that the optimum blade angle has been found. Accordingly, the optimum blade angle αₒₚₜ is then set to the blade angle αᵢ found to be optimum last in the result step 418.

The optimum blade angle found in this manner can be stored together with boundary conditions in a storage step 420. These boundary conditions include in particular the rotor speed n and one or more boundary conditions x, where x can be representative of various boundary conditions, as explained above.

A checking step 422 checks whether the speed has changed significantly, which is indicated in the associated block. For this purpose, it is possible to check whether a speed deviation Δn is greater than a minimum deviation Δn₀. This speed deviation Δn can refer both to an increase in speed and to a reduction in speed.

If the speed has thus changed significantly, the sequence branches to the measurement step 404, in which the new boundary conditions are then recorded accordingly. In particular, the new speed n is recorded, but further boundary conditions, of which the character x is representative, can also be recorded.

Accordingly, the described optimization according to blocks 406 to 416 can then be carried out for new boundary conditions in order to then arrive, according to result step 418, at a result which can again be stored according to the storage step 420. Accordingly, there is then a further entry for an optimum blade angle αₒₚₜ for other boundary conditions, in particular a different speed. A database can be set up in this way, from which, depending on the boundary condition, in particular on the basis of the respective rotor speed, the optimum blade angle αₒₚₜ can be read and set for all three rotor blades.

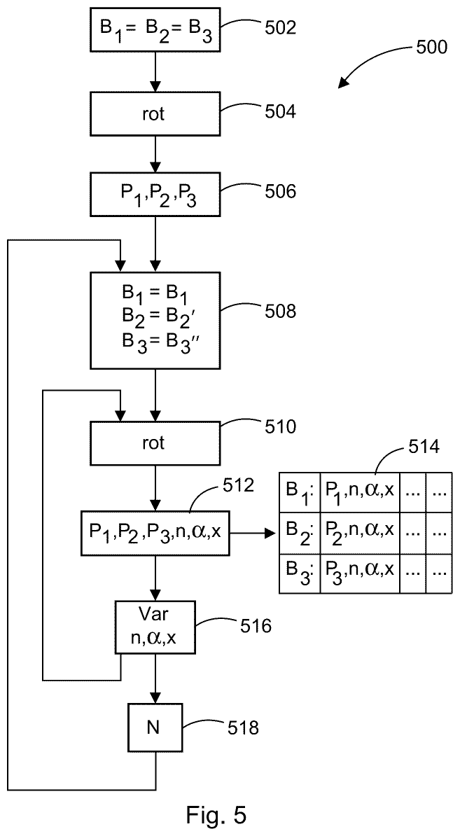

FIG. 5 shows a validation sequence 500. This validation sequence is provided for the purpose of validating at least one rotor blade, i.e. testing it in the field, and confirming the extent to which investigations carried out in simulations also occur in the real use of the rotor blade.

In a starting step 502, the wind power installation initially has three identical rotor blades B₁=B₂=B₃. With this set-up, the wind power installation can be operated in a first operating step 504 and the individual blade powers P₁, P₂ and P₃ can be recorded in a first recording step 506. This can be used to record reference values. However, these three steps 502 to 506 can be dispensable, in particular if not all three rotor blades are replaced during the further validation.

In accordance with the variation step 508, one rotor blade, two rotor blades or all rotor blades are then varied. FIG. 5 illustrates the case in which only the second rotor blade B₂ and the third rotor blade B₃ are varied, namely into the second varied rotor blade B₂ and the third varied rotor blade B₃″. The variation can be replacing the relevant rotor blade with another rotor blade, or providing attachments. For example, according to the example mentioned, attachments can be attached to the two rotor blades B₂ and B₃, which attachments differ in terms of the type and/or position in which they are arranged and/or their number.

This is followed by a second operating step 510, in which the wind power installation is operated with this new configuration.

In the second recording step 512, the individual blade powers P₁, P₂ and P₃ are recorded, as well as boundary conditions therefor. In particular, the speed n and the blade angle α are recorded. In the validation provided here in accordance with the validation sequence 500, the same blade angle is preferably used for all three rotor blades. Further conditions, of which the character x is also representative here, can be taken into account. All these values can then be stored in a storage step 514. Here, provision is made in particular for entries to be stored for each rotor blade B₁, B₂ and B₃, namely the individual blade power P₁, P₂ or P₃ determined for the respective rotor blade and the associated speed n, the associated blade angle α and, if appropriate, further boundary conditions x.

The test step 516 checks whether boundary conditions have changed; in particular, a changed rotor speed n can occur. However, it also comes into consideration that a change is actively made here for validation, e.g. the rotor blade angle α is changed. Other conditions may also change or be changed, of which the character x is representative. A targeted change can also be achieved by changing a generator power. If no changes are made otherwise, this can lead to a change in the speed n. The speed n can therefore change on its own as a result of a change in the wind speed, or can be changed in a targeted manner by changing the generator power or the generator torque.

In any case, the validation in accordance with steps 510 and 512 can be repeated in that case for new boundary conditions. If new individual blade powers are found as a result, these can be stored together with the boundary conditions according to the storage step 514, namely as a further entry. As a result, as many values as possible are recorded in order to thereby examine the rotor blade as comprehensively as possible and to validate it accordingly.

The storage step 514 may also initially include storing basic data relating to the relevant rotor blade. This includes a clear identification of the rotor blade as such and also information on which attachments are arranged where on the rotor blade, or whether there are no attachments. However, such a data set for identifying the rotor blade can also already be stored before the validation steps are activated. The result according to the recording step 512 for the respectively identified rotor blade would then be stored in the storage step 514.

In the test step 516, however, it can also be determined that the boundary conditions have not changed, and a repetition of steps 510 and 512 and, if necessary, 514 can then still be carried out in order to thereby check the previous result which was achieved under the same boundary conditions.

In particular if the changed rotor blades, or the one changed rotor blade, has/have now been measured and validated in sufficient set-ups, a revalidation of further rotor blades or otherwise changed rotor blades comes into consideration. This can be initiated by a revalidation step 518. In that case, the rotor blades are therefore changed according to the variation step 508. With the rotor blades changed in this way, or only one changed rotor blade, the measurement and validation can then be carried out, in particular in accordance with steps 510 and 512. In the storage step 514, a new entry for a new rotor blade is then of course started, that is to say e.g. for a rotor blade B₄ or B₅, etc.

According to the disclosure, the following was also recognized and taken into account.

For rotor blades, there are different types of “add-ons” which are intended to improve the flow states on the rotor blade (vortex generators, trailing edge serrations, Gurney flaps, etc.).

Measurements from a wind tunnel and results from a simulation often promise an improvement in the power curve for the individual measures. Performance gains are usually in the range of 0.2-0.5% of annual energy production (AEP). However, these orders of magnitude cannot be validated in the power curve measurement, since the seasonal fluctuations in the power curve can amount to 1-2% of the AEP. These seasonal fluctuations are important if the power curve is determined in a first period of 2-3 months without “add-ons” on the rotor blade and in a second period with “add-ons” on the rotor blade. The respective resulting AEP formed from the power curves is too strongly influenced by the seasonal fluctuations of the power curve, and the effect of the “add-ons” on the AEP can only be quantified with difficulty.

The question has therefore arisen as to how the results from the wind tunnel and the simulation can be validated. It would be advantageous to validate the “add-ons” in order to be able to decide for or against this measure. Each “add-on” leads to an increase in the price of the rotor blade and possibly makes it more maintenance-intensive. A validation method would be helpful in order to obtain further indications of the mode of operation of the rotor blade “add-ons”.

In the past, the effect of “add-ons” on the power curve has already been validated more frequently. In this case, the first step was to measure a power curve on a wind power installation, which could take 2-3 months, and then the “add-ons” were installed on the rotor blade and the power curve was measured again. Due to the seasonal differences in the power curve, it was very difficult to draw conclusions from the performance of the “add-ons”.

A proposed validation procedure can be as follows.

### Period 1: Measurement Without “Add-Ons” (Calibration)

In order to validate the add-ons on the rotor blade (RB add-ons), the loads on all three rotor blades of the test wind power installation, each rotor blade without “add-ons”, are determined over a statistically sufficient period of time. This involves all or as many load variables as possible, which are influenced by the lift on the rotor blades (e.g. strains, bends, moments, deflections, etc.).

Period 2: Measurement with Installed “Add-Ons” on a Rotor Blade

The “add-ons” are installed on one of the rotor blades. Now it is necessary to measure the loads of the three rotor blades, again in a statistically sufficient period of time. The two rotor blades without “add-ons” are considered to be a reference for the rotor blade with “add-ons”.

### Period 3: Validation

The first period of time allows calibration of the measurement system. Differences in the load measurements due to the measurement technology and the possibly differing rotor blade performance (blade angle error, production accuracy, rotor blade characteristics, etc.) are cleaned up.

The calibration is applied to the data from the measurement with the single equipped rotor blade. The change in load due to the “add-ons” on the rotor blade makes it possible to validate the mode of operation of the “add-ons”. The change in the flow at the rotor blade results in a changed load behavior of the rotor blade compared to the two non-equipped rotor blades which are considered to be a reference. Based on the change in load, conclusions are drawn about the performance of the “add-ons”.

An advantage of the disclosure can also be that the effects of rotor blade “add-ons” on the lift/loads can be recorded and represented.

List of reference signs

| | | | |
|---|---|---|---|
| 200 | Wind power installation | Δn | Speed deviation |
| 202 | Hub | Δn₀ | Minimum deviation |
| 206 | Rotor | B₁, B₂, B₃, | Rotor blades |
| 208 | Rotor blades | P₁, P₂, P₃, | Individual blade power |
| 220 | Swivel load sensor Lₑ | x | Boundary condition(s) |
| 222 | Impact load sensor L_{f} | α/α₁, α₂, α₃ | Blade angle |
| 224 | Rotary sensor | αₒₚₜ | Optimum blade angle |
| 226 | Control device | γ | Rotor rotation angle |
| 400 | Flowchart | 500 | Validation sequence |
| 402 | Start step | 502 | Starting step |
| 404 | Measurement step | 504 | First operating step |
| 406 | Variation step | 506 | First recording step |
| 408 | Adjustment step | 508 | Variation step |
| 410 | Operating step | 510 | Second operating step |
| 412 | Recording step | 512 | Second recording step |
| 414 | Optimization step | 514 | Storage step |
| 416 | Test step | 516 | Test step |
| 418 | Result step | 518 | Revalidation step |
| 420 | Storage step | | |
| 422 | Checking step | | |

1. A method for validating a wind power installation or a component of the wind power installation, wherein the wind power installation has an aerodynamic rotor with a plurality of rotor blades that sweep through a rotor area, wherein
each rotor blade has a blade root with a blade root region,
blade angle of each rotor blade is adjustable; and
for at least one of the plurality of rotor blades, at least one of an individual blade performance capability or an individual blade power is determined for each of the plurality of rotor blades from captured operating data relating to the wind power installation, and
the individual blade performance capability describes a capability of a corresponding rotor blade of the plurality of rotor blades to convert power from wind into a partial rotational power for rotating the rotor, and the individual blade power denotes an amount of power that is converted by the corresponding rotor blade from the wind into a partial rotational power for rotating the rotor, such that a sum of the individual blade power of all of the plurality of rotor blades of the rotor results in a total rotational power of the rotor.

2. The method as claimed in claim 1, wherein the individual blade power is determined based on at least one of:
a load evaluation of the corresponding rotor blade, or
a recorded blade load of the corresponding rotor blade.

3. The method as claimed in claim 1, wherein
a temporal power curve of power generated by the wind power installation is recorded over at least one rotor rotation,
power values of the power curve can each be assigned to a rotor position, and
the at least one individual blade power is determined from the power values, wherein
the at least one individual blade power is determined based on a varying wind speed over the rotor area.

4. The method as claimed in claim 1, wherein
determination of the individual blade power is repeated for at one or more of:
a plurality of revolutions of the rotor,
varying blade angles, and
at different rotor speeds, and
the determination of the individual blade power takes into account ambient conditions including weather conditions, and
a repetition cycle of determining the individual blade power is initiated by detecting one or more of:
a changed blade angle,
a changed rotor speed, and
at least one changed ambient condition including the weather condition.

5. The method as claimed in claim 1, wherein
a load variable of the corresponding rotor blade is recorded in the blade root region,
a swivel load is determined based on the blade angle, and
the individual blade power of the corresponding rotor blade is determined based on the swivel load.

6. The method as claimed in claim 1, wherein
in order to assess blade configurations, the wind power installation is operated in a test mode with differently configured rotor blades, and
in the test mode, a load of one or more of the differently configured rotor blades is respectively recorded as a test load, and
at least one test load is compared with at least one of an additional test load or with a reference load to yield a comparison, and
the individual performance capability of the corresponding rotor blade is assessed based on the comparison.

7. The method as claimed in claim 1, wherein
in order to determine a change in the individual blade performance capability resulting from a blade change in one of the plurality of rotor blades,
the wind power installation is operated in a reference mode without the blade change with the plurality of rotor blades,
during the reference mode, loads of the plurality of rotor blades are recorded as reference loads,
the wind power installation is operated in a test mode with the blade change, the blade change being carried out only for one of the plurality of rotor blades,
in the test mode, loads of the plurality of rotor blades are recorded as test loads, and
a changed individual blade power is determined based on the recorded reference loads and the recorded test loads, and
the change in the individual blade performance capability is determined based on the changed individual blade power.

8. The method as claimed in claim 7, wherein
for the blade change, attachments are added, removed or changed only for one of the plurality of rotor blades, or different attachments are added, removed or changed for the plurality of rotor blades, and
validation for the changed rotor blade is carried out based on at least one of the determined, changed individual performance capability or the changed individual blade power, and/or
power monitoring is carried out based on the determined individual blade powers, wherein
the determined individual blade powers are recorded as blade power curves, and
in order to monitor power, the blade power curves of the plurality of rotor blades are compared.

9. The method as claimed in claim 8, wherein
the blade power curves are recorded as curves of the individual blade power over at least one rotor rotation, and
the blade power curves are set in relation to a revolving rotor position of the respective rotor blade in order to compare values of the blade power curves for the same rotor positions in each case, such that
all blade power curves refer to the same blade position, and that the values of the blade power curves are compared at the same blade positions in each case.

10. The method as claimed in claim 1, wherein
blade angles of the corresponding rotor blade are measured based on the determined individual blade power, wherein
during operation, the blade angle of any of the plurality of rotor blades is changed continuously or in a plurality of steps,
until the individual blade power of the corresponding rotor blade decreases relative to a reference blade power determined by remaining ones of the plurality of rotor blades,
the corresponding rotor blade whose blade angle has been changed is changed until the corresponding rotor blade is in a stall mode, and the blade angle at which the stall mode starts is recorded as the stall blade angle and identifies the rotor blade, and
recording of the stall blade angle, is carried out while simultaneously recording a tip speed ratio and is assigned to the tip speed ratio recorded, with assignment of the stall blade angle to the tip speed ratio is stored in a lookup table for identifying the corresponding rotor blade.

11. The method as claimed in claim 1, wherein
in order to optimize the operation of the wind power installation for at least one rotor blade, the blade angle is gradually changed in each case, and
changes in the individual blade power of the rotor blade whose blade angle has been changed in each case are recorded,
individual blade powers of one or more unchanged rotor blades are used as a reference blade power,
with an optimum blade angle being identified based on the recorded change in the individual blade power of the rotor blade whose blade angle has been changed,
the optimum blade angle is assigned in each case to a recorded tip speed ratio, and stored in a database with the recorded tip speed ratio,
the optimum blade angle for each rotor blade is recorded and stored based on a rotary position of the rotor blade, and
a curve dependent on the blade position is derived based on a plurality of recorded optimum blade angles.

12. The method as claimed in claim 1, wherein
the individual blade powers over at least one rotor revolution are determined for all rotor blades of the wind power installation as blade power curves,
the blade power curves are compared to yield a comparison,
blade deviations are derived from the comparison as deviations with respect to a normal rotor blade and are correctable,
different blade angles including incorrect blade positions, are derived from the comparison and are correctable, and
the individual blade performance capability is derived from a load signal of an impact load sensor without using a load signal from a swivel load sensor.

13. The method as claimed in claim 1, wherein
when comparing changed rotor blades, environmental conditions are taken into account, the environmental conditions including
wind speed, air density and air humidity
comparisons are made for same boundary conditions and changed boundary conditions are removed using a conversion rule, and/or
a wind measurement mast is used to record the environmental conditions.

14. A wind power installation, comprising:
has an aerodynamic rotor with a plurality of rotor blades that sweep through a rotor area, wherein
each rotor blade has a blade root with a blade root region and an adjustable blade angle; and
the wind power installation is is configured to validate the wind power installation or a component of the wind power installation, by
determining, for at least one of the plurality of rotor blades, at least one of an individual blade performance capability or an individual blade power in each case from captured operating data related to the wind power installation, wherein
the individual blade performance capability describes a capability of a corresponding rotor blade of the plurality of rotor blades to convert power from wind into a partial rotational power for rotating the rotor, and the individual blade power denotes an amount of power that is converted by the corresponding rotor blade from the wind into a partial rotational power for rotating the rotor, such that a sum of the individual blade power of all of the plurality of rotor blades of the rotor results in a total rotational power of the rotor.

15. The wind power installation as claimed in claim 14, wherein
the wind power installation has a control device configured to:
control the wind power installation and to record and process measurement signals,
carry out a method as claimed in claim 1, and
identify individual rotor blades on the rotor and assign identified rotor blades to a mounting position on the rotor.

16. The wind power installation as claimed in claim 15, wherein the control device is further configured to:
assign individual blade powers, to the identified rotor blades.

17. The method as claimed in claim 2, wherein the recorded load of the corresponding rotor blade is a recorded swivel load at the blade root or in the blade root region of the corresponding rotor blade.
